(19) United States
(12) Patent Application Publication
(10) Pub. No.: US 2012/0135705 A1
(43) Pub. Date: May 31, 2012

(54) TOOLS FOR MOBILE SAFETY FOR CHILDREN

(76) Inventor: Chet Thaker, Potomac, MD (US)

(21) Appl. No.: 13/296,568

(22) Filed: Nov. 15, 2011

Related U.S. Application Data
(60) Provisional application No. 61/413,623, filed on Nov. 15, 2010.

(51) Int. Cl. H04W 4/00

(52) U.S. Cl. 455/405

(57) ABSTRACT

This invention enables a tool that enables parents to monitor their children's mobile phone usage and alerts the parents when established rules are broken. Further, it alerts parents to intervene when their children might be dealing with bullies, strangers, despair, drugs, or sex issues. In a preferred embodiment, the system displays the GPS location of the phone and time of day on a map when the child violates parental rules. Parents can also learn where the child is by ‘pinging’ the phone to detect the phone's location if the phone is lost or the child is unresponsive.

### CROSS REFERENCE TO RELATED APPLICATION

This application is based upon and claims benefit of copending and co-owned U.S. Provisional Patent Application Ser. No. 61/413,623 entitled “Tools for Mobile Safety for Children”, filed with the U.S. Patent and Trademark Office on Nov. 15, 2010 by the inventor herein, the specification of which is incorporated herein by reference.

### BACKGROUND OF THE INVENTION

1. Field of the Invention

The present invention relates to a system and method for a consumer configurable mobile communication monitoring solution, and more particularly, to a system and method for configuring and/or monitoring the usage criteria of one or more mobile communication devices by a user.

2. Background

In a mobile, digital world, parents need help to gain insight into their children's mobile lives. Without parental guidance, children can easily misuse cell phones to become inadvertent bullies, or the victim of dangerous and disruptive mobile activity, or worse. Parents must set the family rules for using the cell phones.

In general, children's mobile playground is invisible to their parents. Based on surveys, 60% of children have sent texts during classroom hours at school—40% of children do it more than once a day. Parents need to be able to place boundaries on their children's mobile phone usage, such as the time of day and corresponding friends who receive the text messages.

Additionally, parents need to watch for mobile phone threats for their children. It is believed that 25% of juvenile mobile phone users have been harassed or bullied with texts or phone calls. In addition to bullying, children may be subject to stalking, threats, drug use, pedophiles, etc. At least 15% of juvenile mobile phone users have received a sexting image from someone they know. Parents need to be able to monitor the content of the tone and words used in text messages.

Furthermore, parents need to know where the children really are, instead of where they say they are. Parents need to be able to passively monitor the location of a child's mobile phone.

There remains a need, therefore, for a network accessible tool for parents to enable monitoring and controlling mobile phone usage by their children. According to the invention, a tool is established that allows users to monitor, track, and control mobile phone usage over a wireless network.

### SUMMARY OF THE INVENTION

It is, therefore, an object of the present invention to provide a tool for gathering and maintaining information about mobile phone usage that avoids the disadvantages of the prior art.

Another object of the present invention is to provide a tool that makes children's mobile behavior visible to parents. A related object of the present invention is to provide a tool for gathering and maintaining information about children's mobile phone usage that is accessible over a global computer network.

Another object of the present invention is to enable parents to monitor and control their children's mobile phone usage. A related object of the present invention is to enable parents to monitor and control their children's mobile phone access at specific times of day.

A further object of the present invention is enable parents to capture or block their children's text messages bearing specific offensive words. A related object of the present invention is enable parents to analyze usage patterns of a mobile phone, such as when it is being used, to whom a contact is being made, and how often it is done. A further related object is enable parents to watch for usage patterns indicating potential threats.

Another object of the present invention is enable parents to see the children's location on a map. A related object of the present invention is enable parents to find a lost phone by seeing where it was used last.

This invention enables a tool that enables parents to monitor their children's mobile phone usage and alerts the parents when established rules are broken. Further, it alerts parents to intervene when their children might be dealing with bullies, strangers, despair, drugs, or sex issues. In a preferred embodiment, the system displays the GPS location of the phone and time of day on a map when the child violates parental rules. Parents can also learn where the child is by ‘pinging’ the phone to detect the phone's location if the phone is lost or the child is unresponsive.

The tool of the present invention connects parents to their children's mobile lives by providing insight into their children's mobile phone use and behavior. Having an open and honest dialogue about the rules of mobile phone use between parents and children is a critical step towards mobile safety. Children can earn privacy by adhering to their family's mobility rules.

### BRIEF DESCRIPTION OF THE DRAWINGS

The above and other features, aspects, and advantages of the present invention are considered in more detail, in relation to the following description of embodiments thereof shown in the accompanying drawings, in which:

FIG. 1 is a system overview of a communication network for a system according to the present invention.

FIG. 2 is a functional overview of the monitoring ability according to the present invention.

FIG. 3 shows an example of a curfew setting screen according to the present invention.

FIG. 4 shows a curfew matrix according to the present invention.

FIG. 5 shows an overview of report screens according to the present invention.

FIG. 6 shows a phone use detail report according to the present invention.

FIG. 7 shows an example of a family locator map screen according to the present invention.

FIG. 8 shows an example of a child locator detail screen according to the present invention.

FIG. 9 shows an example of a child locator history screen according to the present invention.

### DETAILED DESCRIPTION OF THE INVENTION

The invention summarized above and defined by the enumerated claims may be better understood by referring to the following description, which should be read in conjunction with the accompanying drawings. This description of an embodiment, set out below to enable one to build and use an implementation of the invention, is not intended to limit the enumerated claims, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

Children crave their privacy and independence, particularly from their parents, and rarely tell their parents any details of their mobile lives. The present invention, sometimes referred to herein as Code9, is a tool for smartphones that provides parents with detailed insight into how their children are using their cell phones and enables a parent to help protect their children from unsafe mobile phone behavior. Code9 is texting slang, commonly abbreviated as CD9, meaning, “parents are watching”.

Some of the features of the invention include:
Real-time GPS location tracking
Customizable “curfew” settings for text messages and calls.
Key word text filtering and analysis.
Access to mobile app download history.
Extensive reporting to monitor activities and alerts when mobile rules are broken.

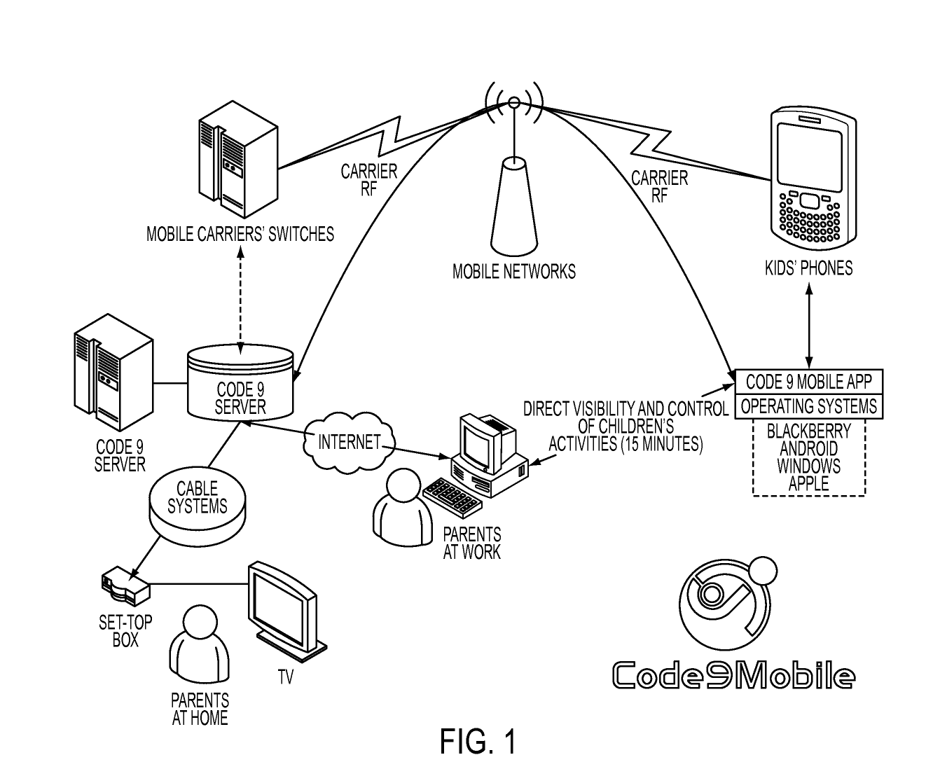

Referring to the drawings, FIG. 1 shows an overview of the system to enable the Code9 tool. The system of the present invention is implemented for on-line user access over a computer network, preferably the Internet and particularly the World Wide Web, using prevailing Internet access and browser software, such as Microsoft's Windows operating system and either Netscape Navigator or Microsoft's Internet Explorer browser. Other access and browser software may be used The system may also be implemented on local area networks, wide area networks, intranets, and individual computers providing direct access to users. The system may include HTML, scripts (e.g., JAVA and VB), cgi applications, activeX data objects, applets, database software, databases, and the like. The Code9 tool is an application that can be loaded onto a child's mobile phone. Using the features of the tool, a parent can monitor mobile phone activity using the wireless telephone network and the Code9 database and server. The invention comprises a network having a centralized database enabling remote access by authorized users.

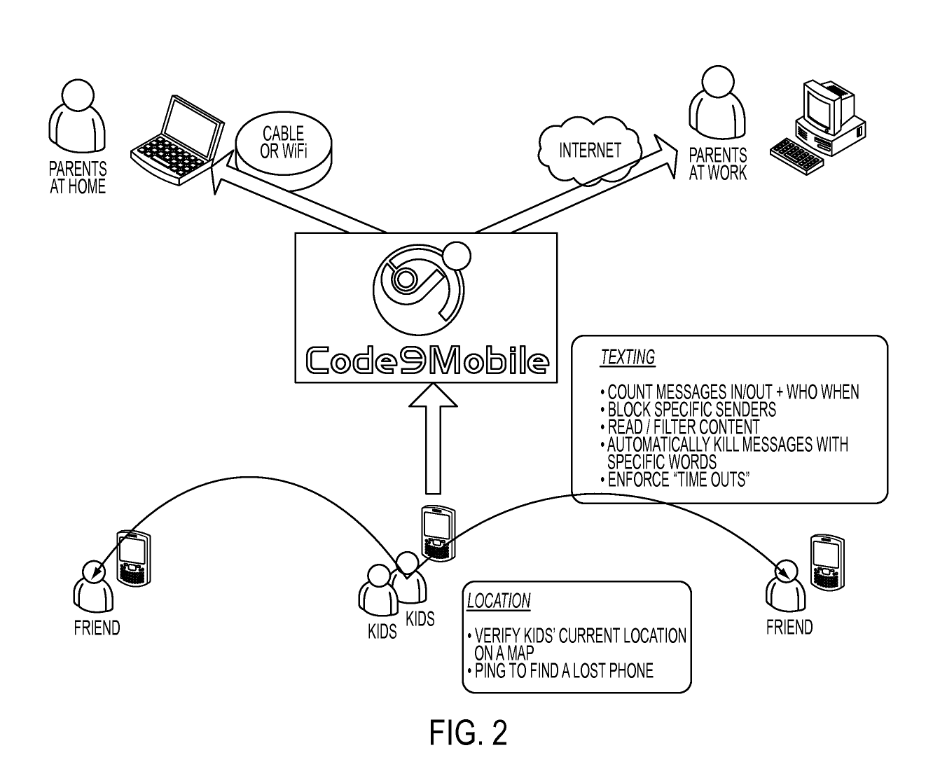

Preferably, the system is divided into discrete intuitive sections to facilitate user navigation. For example, a user may use a personal computer to first access the system through a “Home” page. Typically, the user computer will contain software that enables browsing over a network of computers, such as the Internet. A parent can access the Code9 database and server through the application from any location having Internet access, as illustrated in FIG. 2. A new user may initially access the “Home” page to establish an account in order to download and install the application to a mobile phone. All configuration of the phone is performed through a website. Alternatively and additionally, a user/parent may access the “Home” page to browse the website in order to seek information concerning a tracked phone. Through the website, a user/parent will be able to monitor if the phone is communicating with the servers shown in FIG. 1.

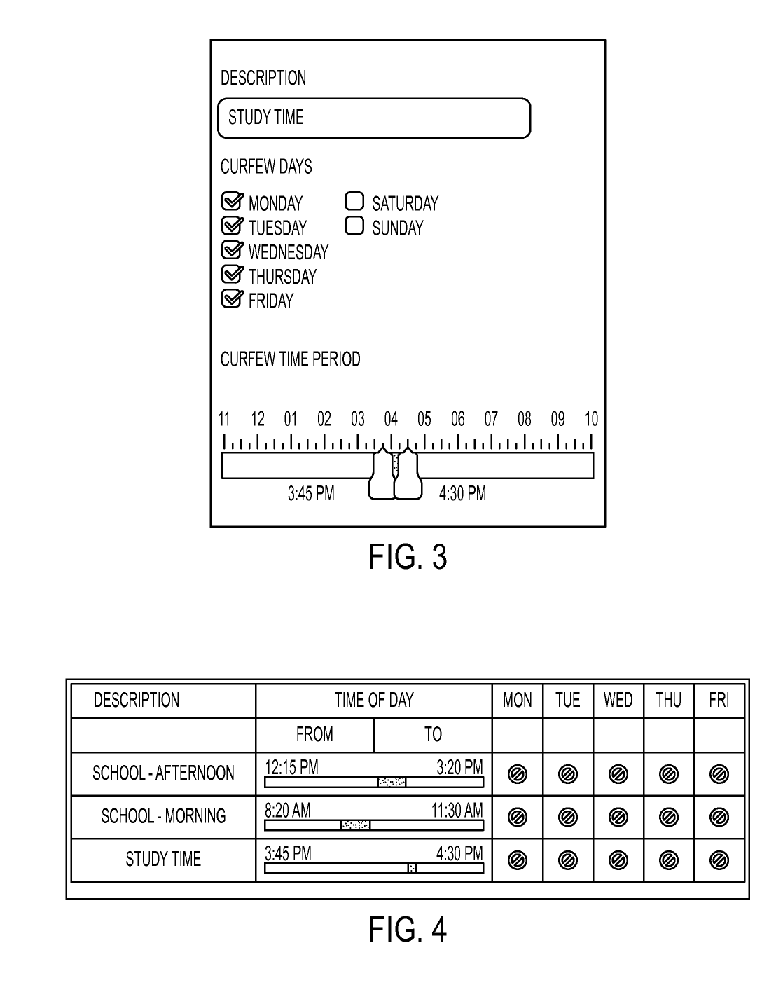

According to features of the invention, Code9 allows a parent to establish curfews at customized times of the day or week, as shown in FIG. 3. During curfews, incoming text messages are queued (held) and delivered after the curfew has ended. This is important in that it does not bluntly block the children's text messages—possibly causing them to miss messages that may be important to them or needlessly worrying about what they may be “missing out on.” Instead, it holds them and delivers all of the messages after the prescribed curfew time.

Curfews can be implemented in ways other than in the traditional sense—they can be used for school, dinner, bedtime, or other times when a parent wants their children focused on things other than their phone. Curfews are an important way the parent can establish boundaries for the children's phones, while ensuring that the parent does not infringe too much on the children's space.

Text messages received during a curfew will be delayed until the curfew is over. A parent can define a “white list” of users (e.g., parents, caregivers) whose messages will always be allowed through, while a “black list” of users will be blocked during the established curfew time. The functionality of the invention can be accessed by a user using a computer to set the curfew times and the “white list” and “black list”. FIG. 4 shows a summary curfew matrix that can be set by the parent.

A parent can tell a great deal about what is going on in their children's lives by looking at what the children are doing on their phones. Knowing whom they are talking and texting to, what they are texting, and what applications they are using can provide valuable insight.

The system of the present invention includes software that can enable creation of reports, dashboards, and alerts for the parents. Typically, children send hundreds of text messages—often in a single day. Even if a parent wanted to look through all of those messages, they would never have the time. The Code9 tool helps a parent to maintain an understanding of what risks their child might be putting himself or herself in, without sacrificing the child's privacy or taking up all of the parent's time. The Code9 tool allows a parent to monitor and analyze general behavior without having to see every specific detail.

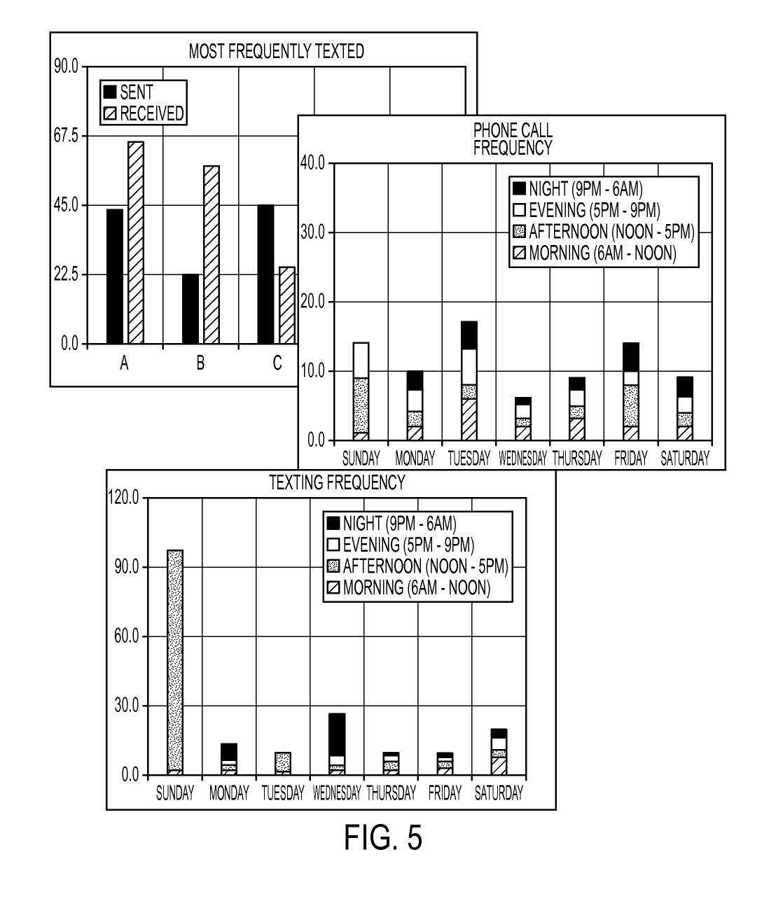

A dashboard provides an overview what is happening on the monitored phone. Charts, such as shown in FIG. 5, quickly identify who is being contacted the most, when phone activity is occurring, and what sort of activity is happening. This overview can be used to spot potential problems quickly and to identify changes in activity over time. Commonly used words are summarized and displayed in a simple form.

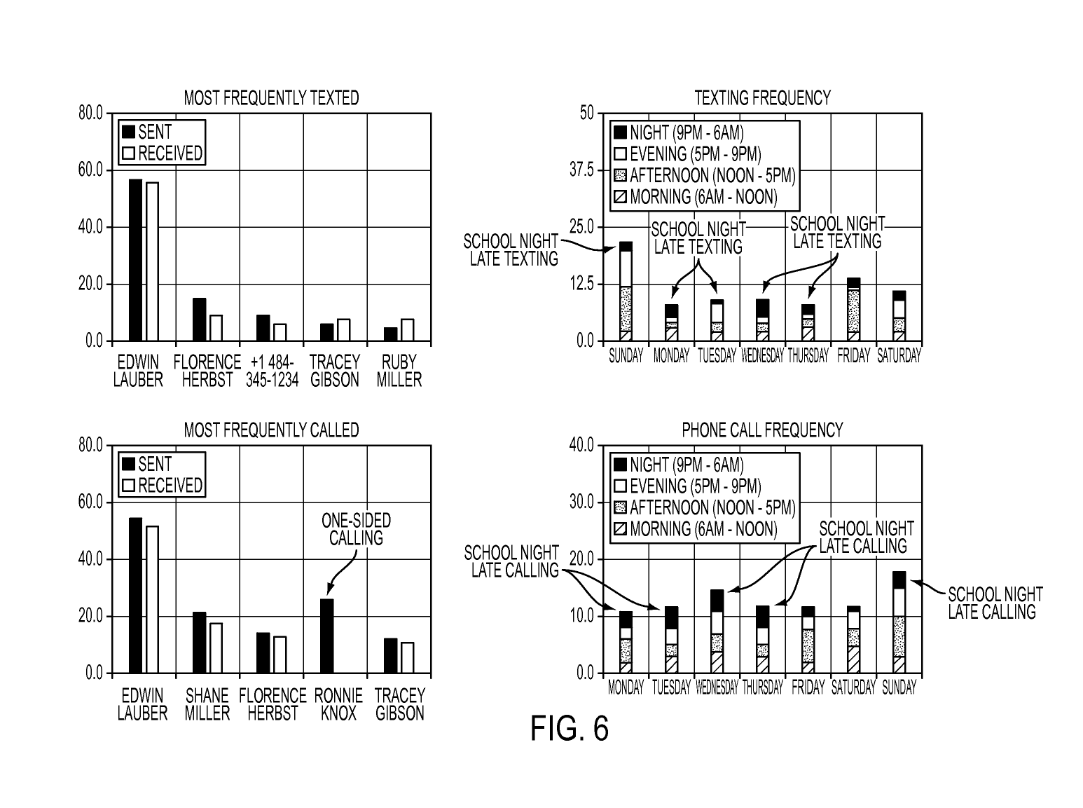

The Code9 tool analyzes text message content for key words or slang selected by parents. Messages containing these words or phrases can be flagged or blocked. Parents can select messages that contain offensive words, or words indicating drug use, bullying, stalking, or despair. A database can be established to provide warnings automatically in order to take special notice of certain words or people the child is communicating, the parent can set up rules that will, if triggered, allow the parent to see the full content of those potentially dangerous messages. Additionally, Code9 provides summary reporting showing how your children use their phones (who, when, how often). Referring to FIG. 6, reports showing the times of day/week, most frequent correspondents, one-sided messages, unknown correspondents, the nature and frequency of “alarm” words, may indicate a potential cause for concern.

In addition to phone activity, the Code9 tool allows a parent to quickly see what applications have been installed and removed, as well as monitor the address book on the phone as friends change and new entries are added and old ones removed. Code9 lists all mobile applications downloaded by the children on their phones. One of the features of the invention enables parents to view a list of new applications that have been downloaded on the phone. The report includes a link to more information about the downloaded applications. Code9 shows the phone's directory of all “named” phone numbers saved on the phone—an easy reference to distinguish the known users from “unknown” numbers calling or called.

All smartphones have a variety of ways to determine the location of the phone. The Code9 tool uses the phones functionality to allow a parent to keep track of the location of all of the phones in an account.

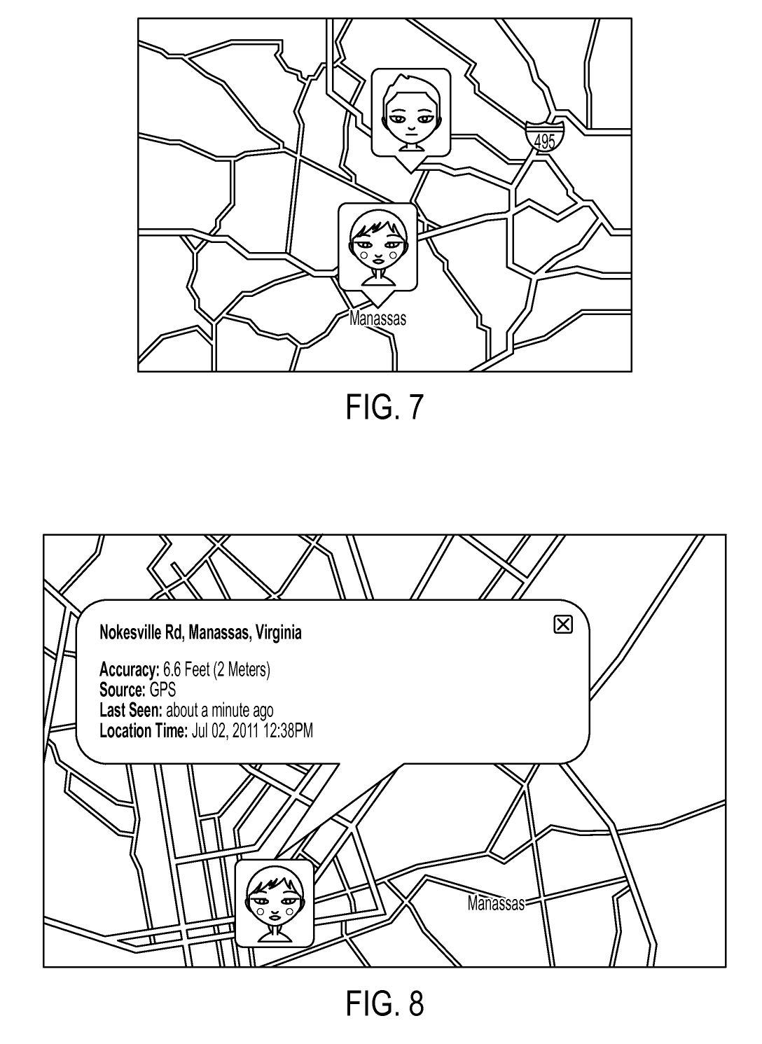

Throughout the day, the Code9 tool keeps track of the general location of the children based on their phone's location. Location information is obtained from the phone using cell phone towers and Wi-Fi access points to determine a general location, which depends largely on the phone's capabilities. As shown in FIG. 7, a parent can see the general location on a website.

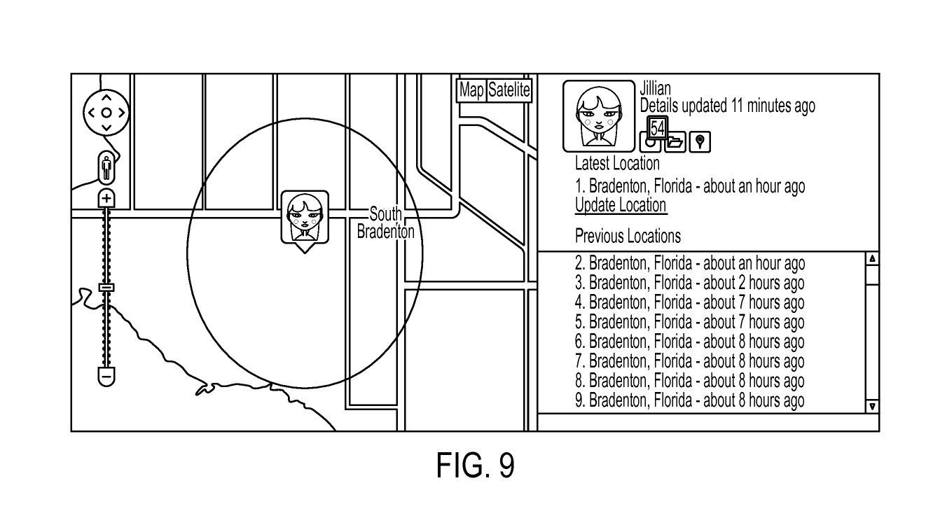

At any time, a parent can “ping” the phone for a more up-to-date location, such as shown in FIG. 8. The Code9 tool will then ask the phone for the current location, using a combination of cellular tower locations and GPS radio. FIG. 9 shows another example of the location service provided by Code9 in which a history of the location of the tracked phone can be displayed on a map.

Typically, users will be able to obtain access to the application for a fee. Once the user has established an account with the Code9 system, a unique identifier is associated with the user/parent. As shown in FIGS. 1 and 2, the user/parent can retrieve any of the reports concerning texting, application download, curfew, and/or location by accessing the Internet.

The invention has been described with references to a preferred embodiment. While specific values, relationships, materials and steps have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art could modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with said underlying concept. It should be understood, therefore, that the invention might be practiced otherwise than as specifically set forth herein. Consequently, the present embodiments are to be considered in all respects as illustrative and not restrictive.

What is claimed is:

1. A computing system for monitoring mobile telephone usage, comprising:
a first computer having a database repository communicatively coupled to at least one other computer creating a networked computing environment; and
a computer processor in data communication with said at least one other computer and said database, said computer processor having executable computer code adapted to:
display a website page accessible by said at least one other computer;
establish at least one account for each of a plurality of users of the networked computing environment and associating each of said users with a unique account in said database;
once an account is established, enable downloading of an application to a mobile phone,
wherein the application downloaded to a mobile phone is operative to relay information about usage of the mobile phone to the database, and
allow retrieval of information about the mobile phone from said database by users having an account,
wherein the website page is associated with said database, and
wherein each account includes a unique identifier associating a specific user and at least one mobile phone with the account.

2. The computing system of claim 1, wherein said executable computer code is stored in said database.

3. The computing system of claim 1, wherein the networked computing environment is configured over at least one of the Internet, an intranet, Ethernet, LAN, and WAN.

4. The computing system of claim 1, wherein the executable computer code is further adapted to provide a user interface.

5. The computing system of claim 1, wherein the executable computer code is further adapted to generate reports of the mobile phone usage.

6. The computing system of claim 5, wherein the reports of the mobile phone usage include information selected from the group consisting of:
telephone text messaging;
telephone voice usage;
telephone application downloads; and
telephone location.

7. The computing system of claim 1, wherein the executable computer code is further adapted to allow control of functions of the mobile phone.

8. The computing system of claim 7, wherein the application downloaded to a mobile phone is operative to relay location information about the phone.

9. The computing system of claim 7, wherein the application downloaded to a mobile phone is operative to establish curfew times for when the phone can be used.

10. A method for monitoring and managing usage of a mobile telephone, said method comprising the steps of:
providing a database repository;
providing a website accessible to at least one user, via a computer system, for on-line interactive communications between said at least one user and said database repository;
offering, at said website, an account in said database repository associated with a unique identifier;
once an account is established, enabling downloading of an application to a mobile phone,
wherein the application downloaded to a mobile phone is operative to relay information about usage of the mobile phone to the database, and
allowing retrieval of information about the mobile phone from said database by users having an account.

11. The method of claim 10, wherein said online interactive communication is conducted over a networked computing environment.

12. The method of claim 11, wherein the networked computing environment is configured over at least one of the Internet, an intranet, Ethernet, LAN, and WAN.

13. The method of claim 10, further comprising:
providing a computer processor in data communication with at least one other computer and said database repository, said computer processor having executable computer code adapted to:
display a website page accessible by said at least one other computer;
establish at least one account for said at least one user of the networked computing environment and associating each of said users with a unique account in said database; and
allow retrieval of information about the mobile phone from said database by users having an account.

14. The method of claim 13, wherein the executable computer code is further adapted to provide a user interface.

15. The method of claim 13, wherein the executable computer code is further adapted to generate reports of the mobile phone usage.

16. The method of claim 13, wherein the executable computer code is further adapted to allow control of functions of the mobile phone.

17. The method of claim 13, wherein the application downloaded to a mobile phone is operative to relay location information about the phone.

18. The method of claim 13, wherein the application downloaded to a mobile phone is operative to establish curfew times for when the phone can be used.
